(19) United States
(12) Patent Application Publication
(10) Pub. No.: US 2004/0093223 A1
(43) Pub. Date: May 13, 2004

(54) Website listing businesses under church membership

(76) Inventor: Ed Lewis Inman, Hendersonville, TN (US)

Correspondence Address: Ed L. Inman, 139 Devonshire Trail, Hendersonville, TN, 37075, US

(21) Appl. No.: 10/290,168

(22) Filed: Nov. 8, 2002

(51) Int. Cl. G06F 17/60

(52) U.S. Cl. 705/1; 705/26

(57) ABSTRACT

This invention uses the technologies of the Internet, website building and databases to create a referral resource system, which list individual contractors and businesses and the products and services they offer under the local church in which they are members. These entries are also categorized by the church's denominational affiliation, the city in which the business operates, and the occupational category.

An individual needing products and services can pull up the website, www.askmychurch.com, on their computer and, through a selection process, be provided a list of those individual contractors meeting their search criteria, according to the church, denomination, city or occupational category they choose to use.

The unique aspect of this invention is that the individual contractors and business managers and owners will be listed under the churches in which they have memberships. They will also be listed under their church's denominational affiliation.

### DRAWINGS (WHEN NECESSARY)

Not Applicable

### OATH OR DECLARATION

[Form PTO/SB/01 attached]

### SEQUENCE LISTING (WHEN NECESSARY)

Not Applicable

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISK APPENDIX

Not Applicable

### BACKGROUND OF THE INVENTION

The field of endeavor to which this invention pertains is the Information Technology field including the World Wide Web, a website, and databases. Individuals and businesses are able to list on a website their names, addresses, phone numbers, email addresses, and a brief description of their products, services, and other relevant information under the church, denomination, city, and work category with which they are affiliated. Users needing those services and products can go to the website and search by state, city, church, denomination, or work category for the individuals and businesses listed accordingly. Unlike the yellow pages and other types of printed directories, this invention uses the Internet, a website, databases, and list the entries with their church affiliation.

### BRIEF SUMMARY OF THE INVENTION

Prior my invention, individuals who needed services or products were restricted to identifying providers of such through the yellow pages or similar printed directories. The desired method of locating someone is a personal referral. My invention enables an individual to locate a provider of products and services in their own local church, or in their denomination, or in other churches in their community. Rather than contacting someone out of a directory, the person can contact someone in his or her own church or in another church in his or her community.

Providers can list their business information along with a brief description of their products and services under their church affiliation, city, and work category. This invention creates another market for these contractors and business owners and managers.

### BRIEF DESCRIPTION OF THE SEVERAL VIEWS OF THE DRAWING

Not Applicable

### DETAILED DESCRIPTION OF THE INVENTION

A website was built with linked databases containing information specifying states, cities, church denominations, churches, and work occupations. Individuals who own or manage businesses or who work as contractors are able to submit information regarding their businesses (name, location, phone numbers) and the products and services they offer under the church to which they are affiliated by membership. This information is also listed under the denomination to which the church is affiliated, the city in which the church is located and the work category under which their business is classified. These individuals submit their information on the website and pay an annual fee by check or credit card. The website administrator checks the submittals for completeness and content and adds them to the database.

Users who are looking for a product or service can pull up the website, www.AskMyChurch.com, and through a selection of drop-down boxes can specify the state, city, and church, denomination, or work category for a list of those who have submitted information corresponding to the user's search.

This invention allows members of churches to identify local contractors and businesses in their own churches and in their own communities. It also provides the local business owners and contractors another market for their products and services. Users can now locate contractors and businesses in local churches in other cities and states to provide services on property they own or for their aged parents, widowed mothers, children in college, etc. Newcomers to a community can easily locate pediatricians, mechanics, etc. according to their church or denominational affiliation.

1. What I claim as my invention is the process of using a computer to facilitate the transaction between an individual needing a product and/or service and a list of contractors and businesses identified with their specific church and denomination or another church and denomination in their own community, comprising:
inputting into the computer an individual or business with their products and/or services listed under the category of state and city and church and denomination and occupation;
inputting into the computer a payment identifier specifying a credit card account, providing payment for the listing, the payment identifier being associated with the individual or business listed under the category of state and city and church and denomination and occupation,
posting the list of individuals and/or businesses with their products and/or services listed under the category of state and city and church and denomination and occupation on the website of www.AskMyChurch.com so that those needing work done for themselves or their businesses or their family or friends can locate the individuals and businesses providing such products and/or services within their own church or denomination in their community, or in another church and denomination in their own community, or in the community where the product and/or service is to be provided.”
